(19) United States
(12) Patent Application Publication
(10) Pub. No.: US 2008/0220132 A1
(43) Pub. Date: Sep. 11, 2008

(54) Cone-shaped tortilla molds and method of cooking conical tortilla shells

(76) Inventor: Nickolas G. Taminich, Buena Park, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/714,441

(22) Filed: Mar. 6, 2007

(51) Int. Cl. A21D 13/00; A23P 1/10

(52) U.S. Cl. 426/138; 99/427

(57) ABSTRACT

The apparatus and method for making conical tortilla shells involves a pair of conical molds with a plurality of apertures therethrough. The first mold has a closed apex at one end, and a widened end at the other, and a handle mounted to the inside at the opening of the first mold, and the second mold has a narrow open apex at one end, and a widened end at the other end, with a handle mounted to the exterior at the opening, to allow the handles to be grasped by a user. In the method, a tortilla is wrapped in a conical shape around the first mold and the molds are put together with the tortilla between them, and with the handles placed together to that the molds and tortilla between them may be manipulated as a unit by a user in cooking the tortilla.

### BACKGROUND OF THE INVENTION

The present invention relates to food and food processing, and more particularly relates to molds and a method of cooking conical tortilla shells.

Taco shells filled with foods, and other types of cooked tortilla wrapped foods are advantageous in that they provide edible containers for eating other foods, can simply and readily be cooked at home, and when cooked and filled with other foods, can be picked up and eaten without utensils. However, children commonly have difficulty eating a filled taco or other tortilla wrapped food in their hands, since they frequently will eat the taco or other tortilla wrapped food from the middle first, leaving the ends of the taco or other tortilla wrapped food unsupported, making it difficult to eat even when the food is held in two hands. Children and adults typically find it easier to eat ice cream or other foods in cones from the top down, even when the food is held in one hand.

One conventional kit and method for cooking conically shaped tortilla cones includes conical molds, and involves wrapping a special tear shaped tortilla patty in a cone shape about the exterior surface of a first mold. The mold is then inserted into another conical mold to secure the wrapped tortilla between the two molds, after which the tortilla is cooked between the two conical molds by deep frying in hot cooking oil. A clip may be used to secure any number of assembled molds and tortilla cones together in a stack during cooking, and removed afterwards.

With another type of conical form, a flat tortilla is first formed or cut in a particular shape with a bottom round side and a flatter top side. The shaped tortilla is wrapped into a conical form, and placed into a hollow interior of a conical perforated mold. A metal conical form is then placed into the conical perforated mold over the tortilla. Several such conically wrapped tortillas held between these inner and outer forms may be placed into a wire cage which is lowered into hot oil for frying the conically wrapped tortillas.

Another method of cooking dough in the shape of edible cones utilizes male and female cone-shaped molds. The dough is placed on an upper portion of the male mold, and the two cone-shaped molds are locked together with the dough in a cone-shaped space defined between the molds. The molds remain locked together during cooking of the dough, such as by immersion in hot oil. An aperture in the conical tip of the female mold allows escape of excess dough as well as steam during cooking. The resulting edible cone may be filled with food to serve as an edible serving container for the food.

It would be desirable to provide a pair of molds with handles that may be grasped and manipulated together by a user for cooking a typical round flat tortilla in a conical shape, so that it can be used as an edible container and filled for serving and eating a wide variety of foods. The present invention fills this and other needs.

### SUMMARY OF THE INVENTION

Briefly, and in general terms, the present invention provides for an apparatus and method for forming and cooking a tortilla in a conical shape. The apparatus includes a first and second conically shaped hollow molds having an inside surface and an exterior surface defining a plurality of apertures therethrough. The first mold has a narrow end with a closed apex, a widened end with an opening having a lip, and a handle mounted to the inside surface and extending a predetermined distance sufficiently beyond the lip of the first mold to allow the handle be grasped by a user. The second mold has a narrow end with an apex with an opening, a widened end with an opening having a lip, and a handle mounted to the exterior surface and extending a predetermined distance corresponding to the handle of the first mold and sufficiently beyond the lip of the second mold to allow the handle be grasped by a user, whereby a tortilla may be placed between the first and second molds for cooking. In a presently preferred aspect, the handles of the first and second molds are rods, although in another variation, the handles of the first and second molds may be formed in the shape of a loop. In another presently preferred aspect, the first and second molds are made of a thin planar material.

The present invention also provides for a method for forming and cooking a tortilla in a conical shape. The method involves providing the first and second molds, placing a round, flat tortilla on a flat surface, placing an external side of the first mold on a top surface of the tortilla with the closed apex of the first mold approximately at a first outer portion of a radial edge of the tortilla, wrapping a second outer portion of the radial edge of the tortilla over the exterior surface of the first mold, wrapping a third outer portion of the radial edge of the tortilla over the exterior surface of the first mold and overlapping the second outer portion of the radial edge of the tortilla, and pressing the tortilla to the exterior surface of the first mold. The apex of the first mold with the tortilla wrapped thereon is inserted into the interior of the second mold, and the handles of the first and second molds are placed together so that the first and second molds and the tortilla therebetween can be manipulated together by a user. The tortilla is then cooked between the first and second molds, and the cooked tortilla may then be removed from between the first and second molds.

These and other aspects and advantages of the invention will become apparent from the following detailed description and the accompanying drawings, which illustrate by way of example the features of the invention.

### BRIEF DESCRIPTION OF THE DRAWINGS

FIG. 1 is a side elevational view of the first and second molds for forming and cooking a tortilla in a conical shape, according to the invention, shown spaced apart.

FIG. 2 is an end view of first and second molds of FIG. 1, shown spaced apart.

FIG. 3 is an end view of first and second molds of FIG. 1, shown placed together.

FIG. 4 is a side elevational view of a variation of the first and second molds of FIG. 1 with handles in the shape of a loop, according to the invention.

FIG. 5 is a top plan view of the first mold placed onto a top surface of a tortilla for wrapping of the tortilla onto the mold in a conical shape.

FIG. 6 is a top plan view of the first mold showing a tortilla wrapped onto the mold in a conical shape.

FIG. 7 is a side elevational view of the first mold showing a tortilla wrapped onto the mold in a conical shape and aligned for insertion into the second mold.

FIG. 8 is a diagrammatic view of the first and second molds assembled with a tortilla pressed between them and placed in a pot with cooking oil for cooking the tortilla in a conical shape.

FIG. 9 is a top plan view of a plurality of tortillas formed and cooked in a conical shape according to the invention stacked together.

### DETAILED DESCRIPTION OF THE PREFERRED EMBODIMENTS

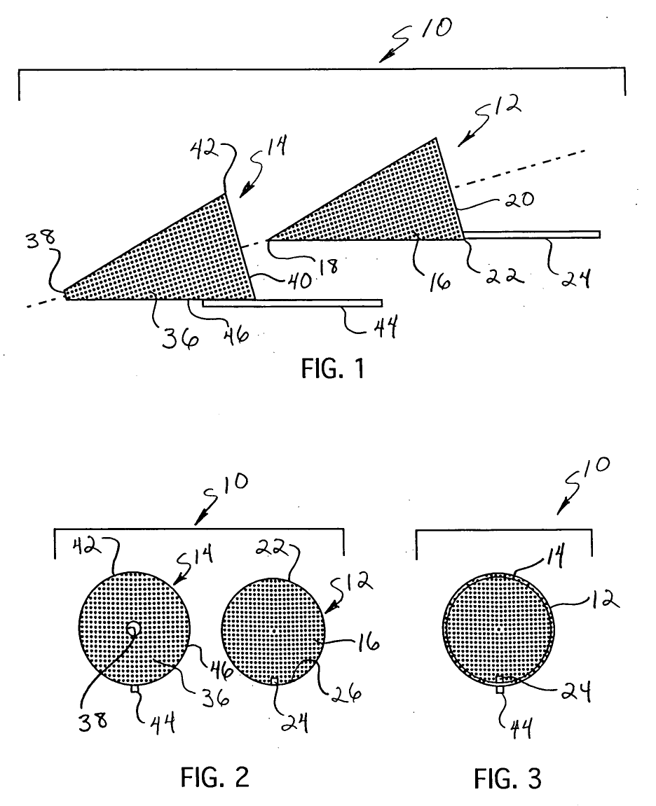

With reference to the drawings, which are exemplary and are provided for illustration and not by way of limitation, the present invention accordingly provides for an apparatus and method for forming and cooking a typical round flat tortilla in a conical shape so that the tortilla can be used as an edible shell for containing foods such as are typically eaten in tacos or burritos, and desserts such as ice cream, for example. Referring to FIGS. 1-3, the apparatus of the invention provides for a pair of molds 10 including a first, inner conically shaped hollow mold 12 and a second, outer conically shaped hollow mold 14, between which an flexible flat tortilla may be placed and secured for cooking, such as in a pot or pan of hot oil, for example.

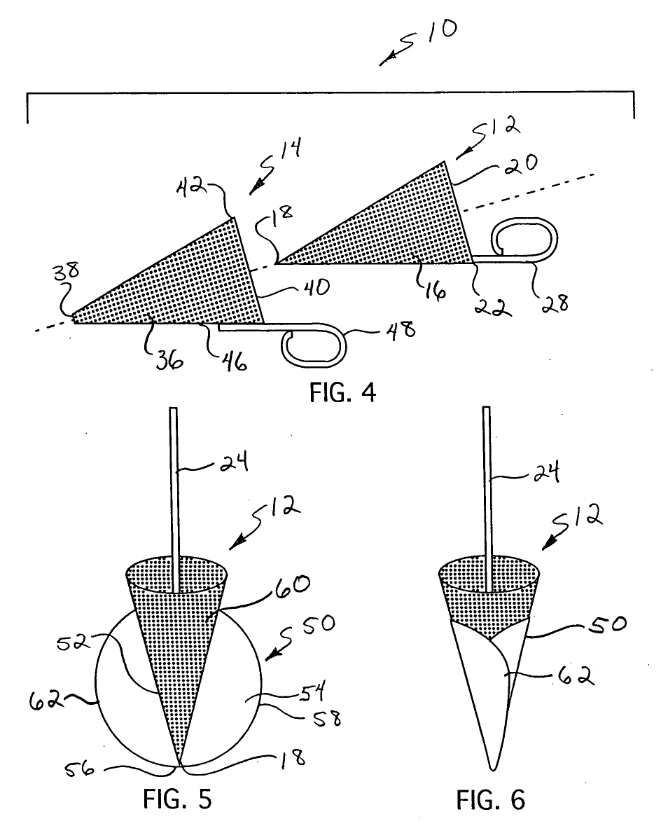

The first, inner mold is preferably made of a thin planar material, such as aluminum or stainless steel, for example, in a hollow conical shape, perforated by a plurality of apertures 16, and having a closed apex 18, and an opening or mouth 20 at the widest portion of the mold, with a lip 22. A handle 24 is mounted to the inside surface 26 of the first, inner mold, typically extending a predetermined distance sufficiently beyond the lip of the mold to allow the handle be grasped by a user with a hot pad or glove, as will be further explained below. In a presently preferred aspect illustrated in FIGS. 1-3 and 5-8, the handle may be a rod extending a predetermined length, such as 3-6 inches beyond the lip of the mold, for example. In an alternate embodiment illustrated in FIG. 4, the first, inner mold may have a handle 28 in the shape of a loop curving radially inwardly away from the lip of the mold, and curving back outwardly toward the lip of the mold.

The second, outer mold is also preferably made of a thin planar material, such as aluminum or stainless steel, for example, in a hollow conical shape, perforated by a plurality of apertures 36, and having an apex with an opening 38, such as approximately ½ inch or ⅜ inch in diameter, for example, and an opening or mouth 40 at the widest portion of the mold, with a lip 42. A handle 44 is mounted to the outside surface 46 of the second, outer mold, typically extending sufficiently beyond the lip of the mold a predetermined distance, typically corresponding to the length of the handle of the first, inner mold, to allow the handle be grasped by a user with a hot pad or glove, as will be further explained below. In a presently preferred aspect illustrated in FIGS. 1-3 and 5-8, the handle may be a rod extending a predetermined length, such as 3-6 inches beyond the lip of the mold, for example. In an alternate embodiment illustrated in FIG. 4, the second, outer mold may have a handle 48 in the shape of a loop curving radially outwardly away from the lip of the mold, and curving back inwardly toward the lip of the mold. The apertures in the first, inner mold and the second, outer mold allow hot oil to pass through the molds to a tortilla placed between the two molds, and the opening at the apex of the second, outer mold facilitates the draining of hot oil from the surface of the tortilla after cooking, as will be further explained below.

In the method of the invention, as is illustrated in FIG. 5, a typical round flat tortilla 50 may be spread out, such as on a generally flat surface, and an external side 52 of the first, inner mold may be placed onto a top surface 54 of the tortilla, with the closed apex of the first, inner mold approximately at a first portion 56 of the outer radial edge of the tortilla. A second portion 58 of the outer radial edge of the tortilla may be then wrapped over the exterior surface 60 of the first, inner mold, and a third portion 62 of the outer radial edge of the tortilla may be then wrapped over the exterior surface of the first, inner mold and overlapping the second portion of the outer radial edge of the tortilla, and the tortilla may be then pressed firmly to the exterior surface of the first, inner mold.

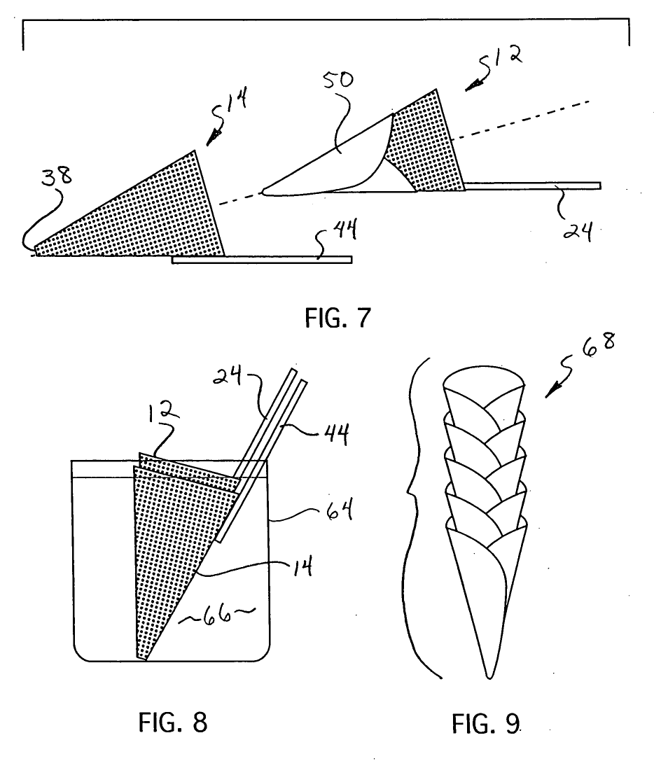

With reference to FIG. 7, a user may grasp the first, inner mold by its handle, and then insert the apex of the first, inner mold, with the conically wrapped tortilla on it, into the interior of the second, outer mold, aligning and placing the handles of the first and second molds together so that the user can grasp the handles of the first and second molds together, as shown in FIGS. 3 and 8. The assembled molds and tortilla pressed therebetween may be placed in a pot or pan 64 of heated cooking oil 66 for an appropriate period of time, such as approximately less than a minute for example, sufficient to cook the tortilla and fix the tortilla in a conical shape, after which the assembled molds and tortilla may be removed by a user from the heated cooking oil by grasping the handles together. As is illustrated in FIG. 9, since such cooked conical tortilla shells 68 formed with the molds of the invention will have a uniform conical taper, the cooked conical tortilla shells conveniently may be stacked for storage, transportation or display.

It will be apparent from the foregoing that while particular forms of the invention have been illustrated and described, various modifications can be made without departing from the spirit and scope of the invention. Accordingly, it is not intended that the invention be limited, except as by the appended claims.

1. An apparatus for forming and cooking a tortilla in a conical shape, comprising:
a first conically shaped hollow mold having an inside surface and an exterior surface defining a plurality of apertures therethrough, said first mold having a narrow end with a closed apex, a widened end with an opening having a lip, and a handle mounted to the inside surface and extending a predetermined distance sufficiently beyond the lip of the first mold to allow the handle be grasped by a user; and
a second conically shaped hollow mold having an inside surface and an exterior surface defining a plurality of apertures therethrough, said second mold having a narrow end with an apex with an opening, a widened end with an opening having a lip, and a handle mounted to the exterior surface and extending a predetermined distance corresponding to the handle of the first mold and sufficiently beyond the lip of the second mold to allow the handle be grasped by a user, whereby a tortilla may be placed between the first and second molds for cooking.

2. The apparatus of claim 1, wherein said first mold is made of a thin planar material.

3. The apparatus of claim 1, wherein said handles of said first and second molds are rods.

4. The apparatus of claim 1, wherein said handles of said first and second molds are formed in the shape of a loop.

5. A method for forming and cooking a tortilla in a conical shape, comprising the steps of:
providing a first conically shaped hollow mold having an inside surface and an exterior surface defining a plurality of apertures therethrough, said first mold having a narrow end with a closed apex, a widened end with an opening having a lip, and a handle mounted to the inside surface and extending a predetermined distance sufficiently beyond the lip of the first mold to allow the handle be grasped by a user;
providing a second conically shaped hollow mold having an inside surface and an exterior surface defining a plurality of apertures therethrough, said second mold having a narrow end with an apex with an opening, a widened end with an opening having a lip, and a handle mounted to the exterior surface and extending a predetermined distance corresponding to the handle of the first mold and sufficiently beyond the lip of the second mold to allow the handle be grasped by a user;
placing a round, flat tortilla on a flat surface;
placing an external side of the first mold on a top surface of the tortilla with the closed apex of the first mold approximately at a first outer portion of a radial edge of the tortilla;
wrapping a second outer portion of the radial edge of the tortilla over the exterior surface of the first mold;
wrapping a third outer portion of the radial edge of the tortilla over the exterior surface of the first mold and overlapping the second outer portion of the radial edge of the tortilla;
pressing the tortilla to the exterior surface of the first mold;
inserting the apex of the first mold with the tortilla wrapped thereon into the interior of the second mold;
placing the handles of the first and second molds together so that the first and second molds and the tortilla therebetween can be manipulated together by a user; and
cooking the tortilla between the first and second molds.

6. The method of claim 5, further comprising the step of removing the tortilla from between the first and second molds following cooking of the tortilla.

7. The method of claim 5, wherein said first mold is made of a thin planar material.

8. The method of claim 5, wherein said handles of said first and second molds are rods.

9. The method of claim 5, wherein said handles of said first and second molds are formed in the shape of a loop.
